(19) United States
(12) Patent Application Publication
(10) Pub. No.: US 2022/0106769 A1
(43) Pub. Date: Apr. 7, 2022

(54) SYSTEM AND METHOD FOR CONTROLLING WORK MACHINE

(71) Applicant: KOMATSU LTD., Tokyo (JP)

(72) Inventor: Yukihisa TAKAOKA, Tokyo (JP)

(21) Appl. No.: 17/426,672

(22) PCT Filed: Apr. 7, 2020
(86) PCT No.: PCT/JP2020/015694

§ 371 Date: Jul. 29, 2021

(30) Foreign Application Priority Data
Apr. 24, 2019 (JP) 2019-082976

(51) Int. Cl. E02F 9/20; E02F 9/26; E02F 3/84

(52) U.S. Cl. CPC E02F 9/2054; E02F 9/262; E02F 9/2004; E02F 3/841; E02F 9/205

(57) ABSTRACT

A system controls a work machine at a work site. The system includes a machine position sensor that detects a position of the work machine, a shovel position sensor that detects a position of a shovel, and a controller that acquires machine position data indicative of the position of the work machine and shovel position data indicative of the position of the shovel. The controller determines a work area that includes a plurality of work lanes extending in a predetermined work direction at the work site. The controller allocates the work machine to the plurality of work lanes. The controller determines, as a work restricted area of the work machine, a predetermined range in which the position of the shovel is used as a reference at the work site. The controller controls the work machine so that automatic operation of the work machine in the work restricted area is restricted.

### CROSS-REFERENCE TO RELATED APPLICATIONS

This application is a U.S. National stage application of International Application No. PCT/JP2020/015694, filed on Apr. 7, 2020. This U.S. National stage application claims priority under 35 U.S.C. § 119(a) to Japanese Patent Application No. 2019-082976 filed in Japan on Apr. 24, 2019, the entire contents of which are hereby incorporated herein by reference.

### BACKGROUND

### Field of the Invention

The present disclosure relates to a system and a method for controlling a work machine.

### Background Information

A shovel and a work machine perform work at a work site in cooperation with each other. For example, in WO2018/039709, a bulldozer and a shovel perform digging in the same work area on surface mining.

### SUMMARY

Automatic operation of a work machine improves efficiency of a system. In this case, it is required to avoid interference between a shovel and a work machine that work in the same work area. An object of the present disclosure is to prevent the work machine from interfering with the shovel during the automatic operation.

A system according to a first aspect is a system for controlling a work machine at a work site. The system includes a machine position sensor, a shovel position sensor, and a controller. The machine position sensor detects a position of the work machine at the work site. The shovel position sensor detects a position of the shovel at the work site. The controller acquires machine position data and shovel position data. The machine position data indicates the position of the work machine. The shovel position data indicates the position of the shovel. The controller determines a work area that includes a plurality of work lanes at the work site. The plurality of work lanes extend in a predetermined work direction. The controller allocates the work machine to the plurality of work lanes. The controller determines, as a work restricted area of the work machine, a predetermined range in which the position of the shovel is used as a reference at the work site. The controller controls the work machine so that automatic operation of the work machine in the work restricted area is restricted.

A method according to a second aspect is a method for controlling a work machine at a work site. The method includes the following processes. A first process is to acquire machine position data. The machine position data indicates a position of the work machine at the work site. A second process is to acquire shovel position data. The shovel position data indicates a position of a shovel at the work site. A third process is to determine a work area that includes a plurality of work lanes at the work site. The plurality of work lanes extend in a predetermined work direction. A fourth process is to allocate the work machine to the plurality of work lanes. A fifth process is to determine, as a work restricted area of the work machine, a predetermined range in which the position of the shovel is used as a reference at the work site. A sixth process is to control the work machine so that automatic operation of the work machine in the work restricted area is restricted.

According to the present disclosure, a predetermined range in which the position of the shovel is used as the reference at the work site is determined as the work restricted area. Then, the automatic operation of the work machine in the work restricted area is restricted. As a result, it is possible to prevent the work machine from interfering with the shovel during the automatic operation.

### BRIEF DESCRIPTION OF DRAWINGS

FIG. 1 is a schematic view illustrating a control system for a work machine according to an embodiment.

FIG. 2 is a side view of the work machine.

FIG. 3 is a schematic diagram illustrating a configuration of the work machine.

FIG. 4 is a flowchart illustrating processes of automatic control executed by a controller.

FIG. 5 is a side view illustrating an example of an actual topography.

FIG. 6 is a top view of a work site illustrating an example of a work area.

FIG. 7 is a top view of the work site illustrating an example of a work restricted area.

FIG. 8 is a top view of the work site during automatic operation.

FIG. 9 is a flowchart illustrating processes of automatic control executed by the controller.

FIG. 10 is a top view of the work site illustrating an example of the work restricted area when a shovel moves.

### DETAILED DESCRIPTION OF EMBODIMENT(S)

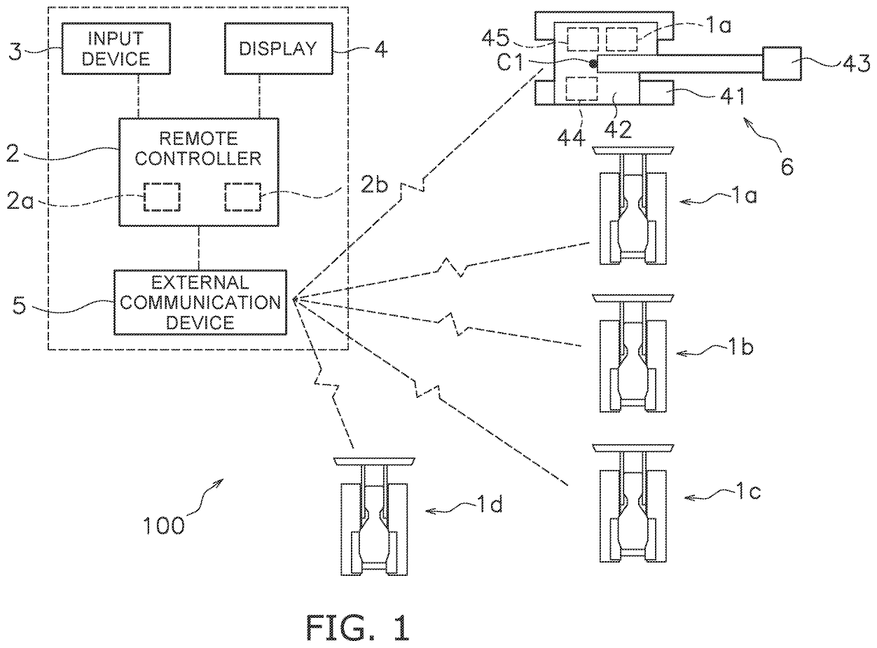

Hereinafter, a control system for a work machine according to an embodiment will be described with reference to the drawings. FIG. 1 is a schematic view illustrating a control system 100 of the work machine according to the embodiment. As illustrated in FIG. 1, the control system 100 includes work machines 1a to 1d, a remote controller 2, an input device 3, a display 4, and an external communication device 5. The control system 100 controls the work machines 1a to 1d disposed at a work site such as a mine. The work machines 1a to 1d according to the present embodiment are bulldozers.

The remote controller 2, the input device 3, the display 4, and the external communication device 5 are disposed outside the work machines 1a to 1d. The remote controller 2, the input device 3, the display 4, and the external communication device 5 may be disposed in, for example, an external management center outside the work machines 1a to 1d. The remote controller 2, the input device 3, the display 4, and the external communication device 5 may be disposed on a shovel 6 at the work site. The remote controller 2, the input device 3, the display 4, and the external communication device 5 may be disposed in both the external management center and the shovel 6. The remote controller 2 remotely controls the work machines 1a to 1d. The number of the work machines remotely controlled by the remote controller 2 is not limited to four and may be less than four or greater than four.

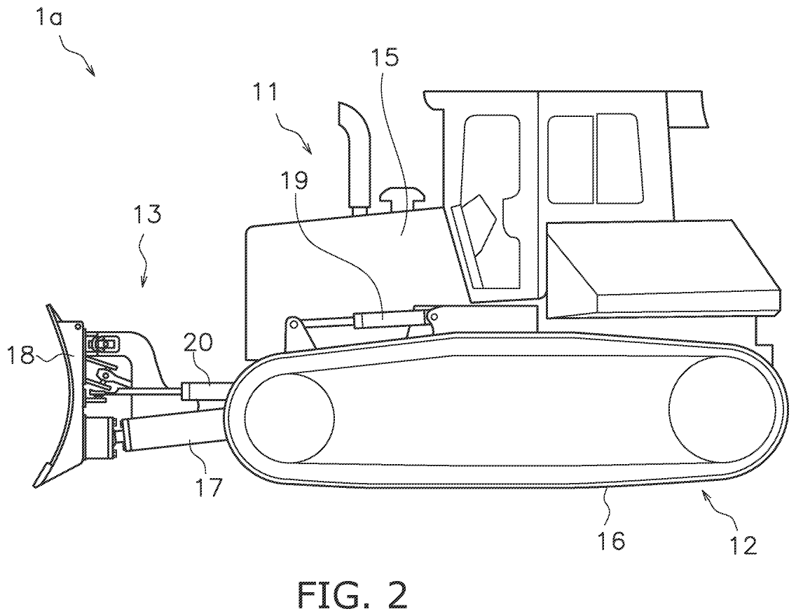

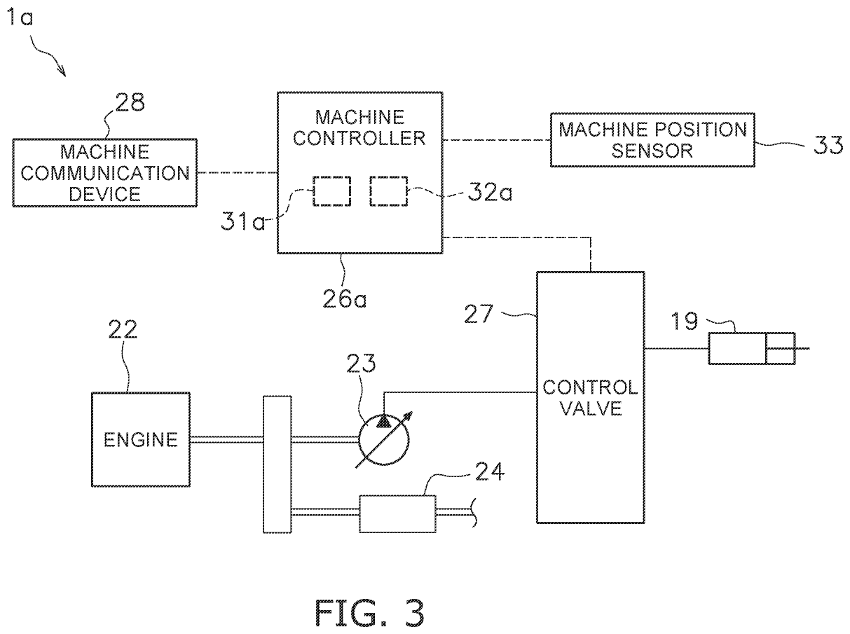

FIG. 2 is a side view of the work machine 1a. FIG. 3 is a block diagram illustrating a configuration of the work machine 1a. Hereinafter, the work machine 1a will be described, but a configuration of each of the other work machines 1b to 1d is the same as that of the work machine 1a. As illustrated in FIG. 2, the work machine 1a includes a vehicle body 11, a travel device 12, and a work implement 13. The vehicle body 11 includes an engine compartment 15. The travel device 12 is attached to the vehicle body 11. The travel device 12 includes a pair of left and right crawler belts 16. Only the left crawler belt 16 is illustrated in FIG. 2. The work machine 1a travels due to the rotation of the crawler belts 16.

The work implement 13 is attached to the vehicle body 11. The work implement 13 includes a lift frame 17, a dozing blade 18, and a lift cylinder 19. The lift frame 17 is attached to the vehicle body 11 such as to be movable up and down. The lift frame 17 supports the dozing blade 18. The dozing blade 18 moves up and down accompanying the movements of the lift frame 17. The lift frame 17 may be attached to the travel device 12. The lift cylinder 19 is coupled to the vehicle body 11 and the lift frame 17. Due to the extension and contraction of the lift cylinder 19, the lift frame 17 moves up and down.

As illustrated in FIG. 3, the work machine 1a includes an engine 22, a hydraulic pump 23, a power transmission device 24, and a control valve 27. The hydraulic pump 23 is driven by the engine 22 to discharge hydraulic fluid. The hydraulic fluid discharged from the hydraulic pump 23 is supplied to the lift cylinder 19. Although one hydraulic pump 23 is illustrated in FIG. 3, a plurality of hydraulic pumps may be provided.

The power transmission device 24 transmits driving force of the engine 22 to the travel device 12. The power transmission device 24 may be a hydro static transmission (HST), for example. Alternatively, the power transmission device 24 may be a transmission having a torque converter or a plurality of transmission gears. Alternatively, the power transmission device 24 may be another type of transmission.

The control valve 27 is disposed between a hydraulic actuator such as the lift cylinder 19 and the hydraulic pump 23. The control valve 27 controls the flow rate of the hydraulic fluid supplied from the hydraulic pump 23 to the lift cylinder 19. The control valve 27 may be a pressure proportional control valve. Alternatively, the control valve 27 may be an electromagnetic proportional control valve.

The work machine 1a includes a machine controller 26a and a machine communication device 28. The machine controller 26a controls the travel device 12 or the power transmission device 24, thereby causing the work machine 1a to travel. The machine controller 26a controls the control valve 27, thereby causing the dozing blade 18 to move up and down.

The machine controller 26a is programmed to control the work machine 1a based on acquired data. The machine controller 26a includes a processor 31a and a storage device 32a. The processor 31a is, for example, a central processing unit (CPU). Alternatively, the processor 31a may be a processor different from the CPU. The processor 31a executes processes for controlling the work machine 1a according to a program.

The storage device 32a includes a non-volatile memory such as a ROM and a volatile memory such as a RAM. The storage device 32a may include an auxiliary storage device such as a hard disk or a solid state drive (SSD). The storage device 32a is an example of a non-transitory computer-readable recording medium. The storage device 32a stores computer commands and data for controlling the work machine 1a.

The machine communication device 28 wirelessly communicates with the external communication device 5. For example, the machine communication device 28 communicates with the external communication device 5 by a wireless LAN such as Wi-Fi (registered trademark), a mobile communication such as 3G, 4G, or 5G, or another type of wireless communication system.

The work machine 1a includes a machine position sensor 33. The machine position sensor 33 may include a global navigation satellite system (GNSS) receiver such as a global positioning system (GPS). Alternatively, the machine position sensor 33 may include a receiver for another positioning system. The machine position sensor 33 may include a motion sensor such as an inertial measurement unit (IMU), a ranging sensor such as a Lidar, or an image sensor such as a stereo camera. The machine position sensor 33 outputs machine position data to the machine controller 26a. The machine position data indicates a position of the work machine 1a.

The external communication device 5 illustrated in FIG. 1 wirelessly communicates with the machine communication device 28. The external communication device 5 transmits a command signal from the remote controller 2 to the machine communication device 28. The machine controller 26a receives the command signal via the machine communication device 28. The external communication device 5 receives the machine position data of the work machine 1a via the machine communication device 28.

The input device 3 is a device configured to be operated by an operator. The input device 3 receives an input command from the operator and outputs an operation signal corresponding to the input command to the remote controller 2. The input device 3 outputs the operation signal corresponding to operation by the operator. The input device 3 outputs the operation signal to the remote controller 2. The input device 3 may include a pointing device such as a mouse or a trackball. The input device 3 may include a keyboard. Alternatively, the input device 3 may include a touch screen.

The display 4 includes a monitor such as a CRT, an LCD, or an OELD. The display 4 receives an image signal from the remote controller 2. The display 4 displays an image corresponding to the image signal. The display 4 may be integrated with the input device 3. For example, the input device 3 and the display 4 may include a touch screen.

The remote controller 2 remotely controls the work machines 1a to 1d. The remote controller 2 receives the operation signal from the input device 3. The remote controller 2 outputs the image signal to the display 4. The remote controller 2 includes a processor 2a and a storage device 2b. The processor 2a is, for example, a central processing unit (CPU). Alternatively, the processor 2a may be a processor different from the CPU. The processor 2a executes processes for controlling the work machines 1a to 1d according to a program. In the following description, the description regarding the processes executed by the remote controller 2 may be interpreted as the processes executed by the processor 2a.

The storage device 2b includes a non-volatile memory such as a ROM and a volatile memory such as a RAM. The storage device 2b may include an auxiliary storage device such as a hard disk or a solid state drive (SSD). The storage device 2b is an example of a non-transitory computer-readable recording medium. The storage device 2b stores computer commands and data for controlling the work machines 1a to 1d.

The remote controller 2 communicates with the shovel 6 via the external communication device 5. The shovel 6 is disposed at the work site together with the work machines 1a to 1b. As illustrated in FIG. 1, the shovel 6 includes a travel device 41, a rotating body 42, and a work implement 43. The travel device 41 includes, for example, a pair of crawler belts. The rotating body 42 is configured to rotate around a rotation center C1 with respect to the travel device 41. The work implement 43 includes, for example, a bucket, an arm, and a boom. The shovel 6 performs work such as digging with the work implement 43.

The shovel 6 includes a shovel position sensor 44 and a shovel controller 45. The shovel position sensor 44 detects a position of the shovel 6. The shovel position sensor 44 outputs shovel position data indicative of the position of the shovel 6. The shovel position sensor 44 may have the same configuration as that of the machine position sensor 33.

The shovel controller 45 controls the shovel 6. The shovel controller 45 includes a processor and a storage device in the same manner as the remote controller 2. The shovel controller 45 transmits the shovel position data to the external communication device 5 via a communication device that is not illustrated. The remote controller 2 receives the shovel position data. The shovel 6 may be remotely controlled in the same manner as the work machines 1a to 1d. Alternatively, the shovel 6 may be manually controlled by a (shovel) operator who rides on the shovel 6.

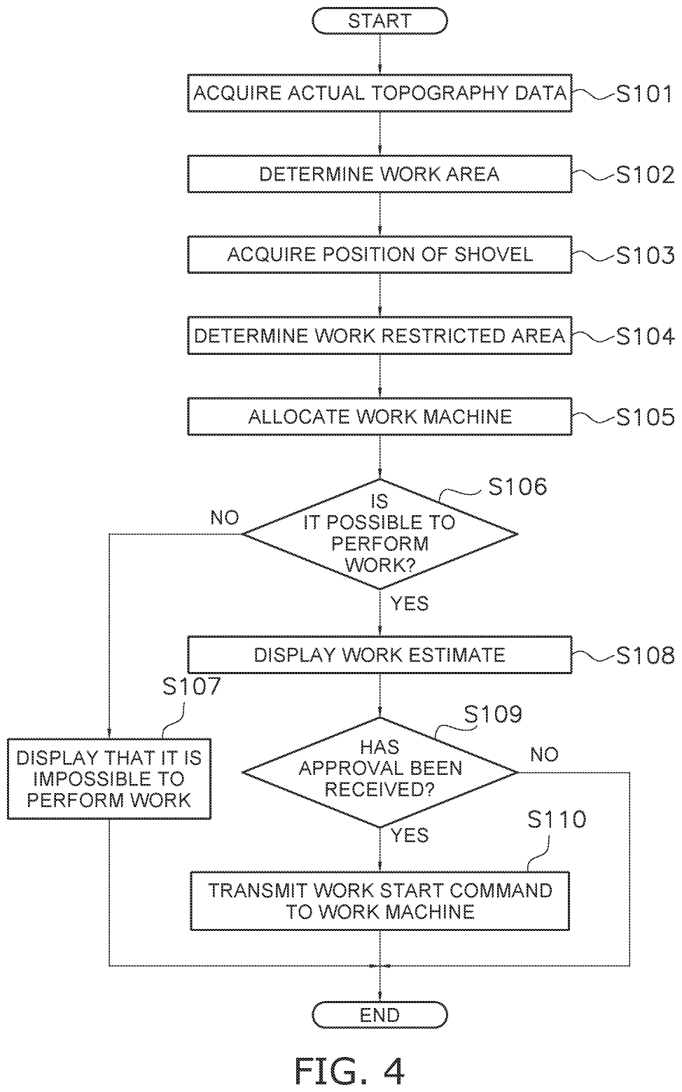

Next, automatic operation of the work machines 1a to 1d executed by the control system 100 will be described. FIG. 4 is a flowchart illustrating processes executed by the remote controller 2. The remote controller 2 executes the processes illustrated in FIG. 4, thereby setting an automatic operation plan and causing the work machines 1a to 1d to perform work according to the automatic operation plan.

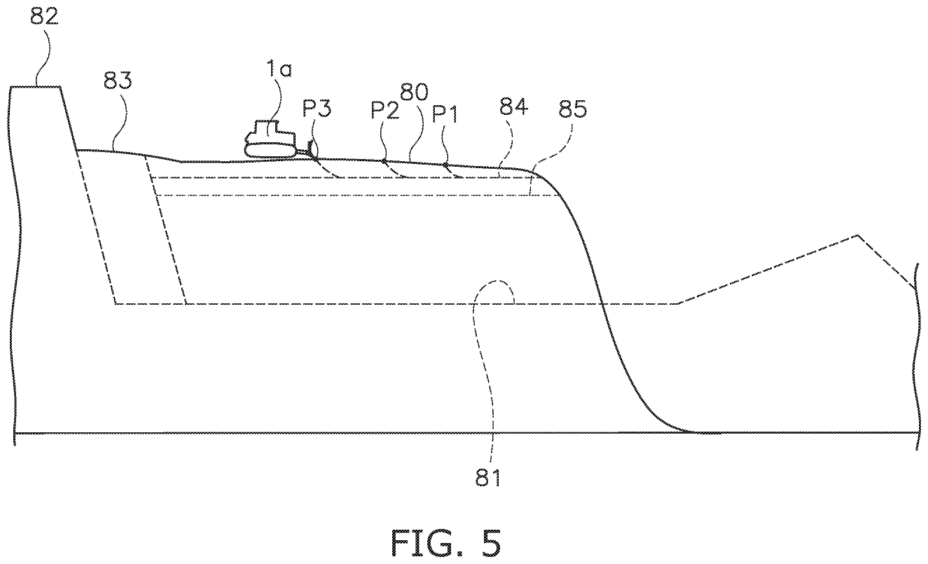

As illustrated in FIG. 4, in step S101, the remote controller 2 acquires actual topography data. The actual topography data indicates an actual topography of the work site. FIG. 5 is a side view illustrating an example of an actual topography 80. The actual topography data includes coordinates and heights of a plurality of points on the actual topography 80.

The work machines 1a to 1d dig the actual topography 80 by automatic operation so that the actual topography 80 has a shape along a final target topography 81. The work site includes a highwall 82. The highwall 82 is a wall of topsoil covering an ore layer at the work site and is exposed at a periphery of a part of the work site in the process of removing the topsoil. A shovel digging area 83 is disposed in a vicinity of the highwall 82. For example, the shovel digging area 83 is a range of a predetermined distance from the highwall 82. The predetermined distance is set according to the length of each of the work machines 1a to 1d. In the shovel digging area 83, the shovel 6 performs digging.

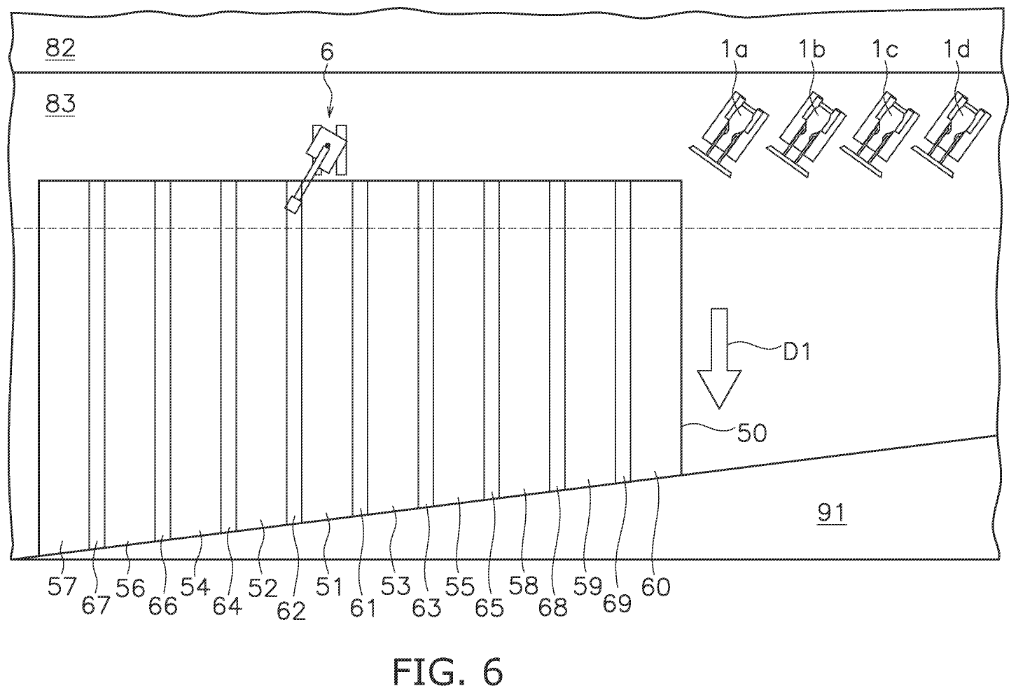

In step S102, the remote controller 2 determines a work area 50 at the work site. FIG. 6 is a top view of the work site illustrating an example of the work area 50. The work area 50 includes a plurality of work lanes 51 to 60. The plurality of work lanes 51 to 60 extend in a predetermined work direction D1. The remote controller 2 may determine the work area 50 according to operation by the operator using the input device 3. Alternatively, the remote controller 2 may automatically determine the work area 50.

The actual topography data includes data indicative of a position of a work prohibited area 91. The work prohibited area 91 includes, for example, a position of a cliff. The remote controller 2 does not set the work area 50 in the work prohibited area 91.

The remote controller 2 determines a disposition of the plurality of work lanes 51 to 60 based on work data and machine data. The work data indicates the work direction D1 in the work area 50. The operator can select the work direction D1 using the input device 3. The remote controller 2 acquires the work direction D1 based on an operation signal from the input device 3. Alternatively, the work direction D1 may be automatically determined by the remote controller 2.

The remote controller 2 determines the width of each of the work lanes 51 to 60 based on the machine data. The machine data includes the dimension of each of the work machines 1a to 1d in the width direction. For example, the dimension of each of the work machines 1a to 1d in the width direction is the width dimension of the dozing blade 18. The remote controller 2 determines the dimension of each of the work machines 1a to 1d in the width direction as the width of each of the work lanes 51 to 60.

The work area 50 includes digging wall areas 61 to 69. The digging wall areas 61 to 69 are disposed. The digging wall areas 61 to 69 are disposed between the work lanes 51 to 60. The remote controller 2 determines the width of each of the digging wall areas 61 to 69 based on the machine data. The remote controller 2 determines a value less than the width dimension of the dozing blade 18 as the width of each of the digging wall areas 61 to 69. The remote controller 2 displays an image indicative of the work area 50 on the display 4.

The disposition of the work lanes and the digging wall areas is not limited to that illustrated in FIG. 6 and may be changed. For example, the number of the work lanes is not limited to 10 and may be less than 10 or greater than 10. The number of the digging wall areas is not limited to 9 and may be less than 9 or greater than 9.

In step S103, the remote controller 2 acquires a position of the shovel 6. The remote controller 2 acquires the position of the shovel 6 from the shovel position data.

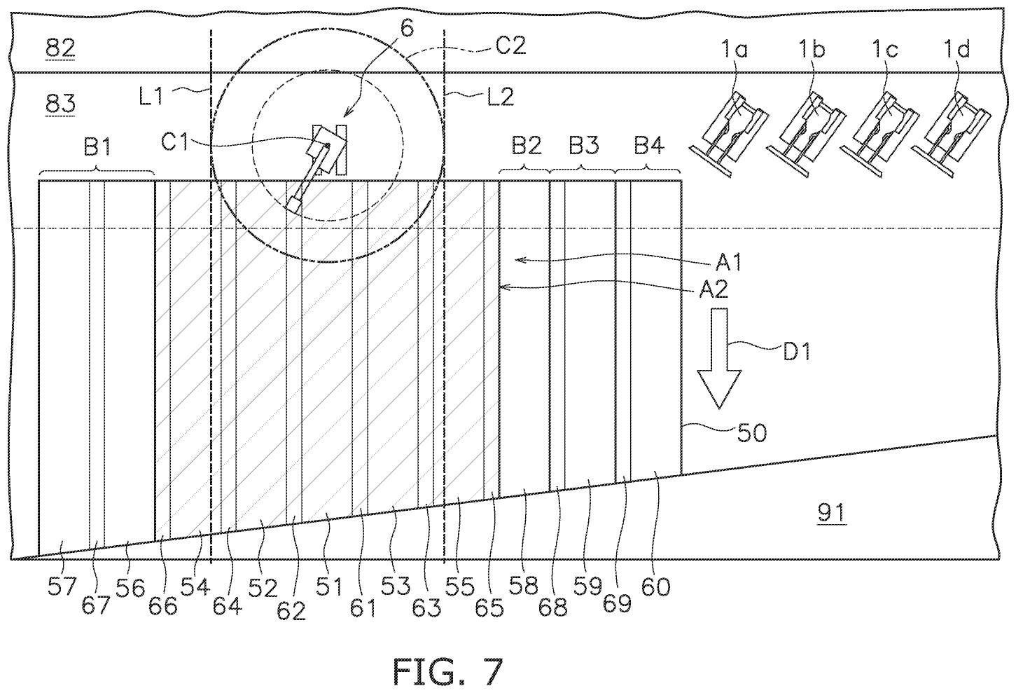

In step S104, the remote controller 2 determines a work restricted area A1. As illustrated in FIG. 7, the remote controller 2 determines, as the work restricted area A1, a predetermined range in which the position of the shovel 6 is used as a reference at the work site. The work restricted area A1 is indicated by a hatched portion in FIG. 7. The work restricted area A1 includes a first restricted area A2. The remote controller 2 determines, as the first restricted area A2, a range that includes the work lane positioned in a range of a predetermined distance from the position of the shovel 6 to in the width direction of the work lanes 51 to 60.

For example, the remote controller 2 determines a first circle C2 centered on the rotation center C1 of the shovel 6. The radius of the first circle C2 is larger than a maximum rotation radius of the shovel 6. The remote controller 2 determines a pair of tangents L1 and L2 (hereinafter referred to as “first tangent L1” and “second tangent L2”) of the first circle C2 extending in the predetermined work direction D1. The remote controller 2 determines, as the first restricted area A2, the work lane overlapping a range between the first tangent L1 and the second tangent L2 and the digging wall area adjacent to the work lane. The remote controller 2 may set a plurality of first circles C2, C3, . . . centered on the rotation center C1 of the shovel 6. Each of the plurality of first circles C2, C3, . . . may have a radius that is larger than the maximum rotation radius and is different from each other. In this case, the operator may select the first circle by operating the input device 3. The remote controller 2 may determine the first circle based on an output signal from the input device 3.

In an example illustrated in FIG. 7, the first tangent L1 overlaps a fourth work lane 54. The second tangent L2 overlaps a fifth work lane 55. The range between the first tangent L1 and the second tangent L2 overlaps the first to fifth work lanes 51 to 55. Therefore, the remote controller 2 determines, as the first restricted area A2, the range that includes the first to fifth work lanes 51 to 55 and the first to sixth digging wall areas 61 to 66.

In step S105, the remote controller 2 allocates the work machines 1a to 1d. The remote controller 2 allocates the work machines 1a to 1d to the plurality of work lanes 51 to 60. The operator allocates the work machines 1a to 1d to the plurality of work lanes 51 to 60 using the input device 3. One work machine may be allocated to one or more work lanes. The remote controller 2 determines the work machines that are allocated to the plurality of work lanes based on an operation signal from the input device 3. Alternatively, the remote controller 2 may automatically determine the work machines allocated to the plurality of work lanes. However, the remote controller 2 does not allocate the work machine to the work lane positioned in the first restricted area A2. That is, the remote controller 2 disables allocation of the work machine to the work lane positioned in the first restricted area A2.

In step S106, the remote controller 2 determines whether it is possible to perform work. The remote controller 2 determines whether it is possible to perform work in each of the work lanes based on the actual topography data. For example, the remote controller 2 determines that it is impossible to perform work in the work lane that includes excessive unevenness, irregularity, or inclination. When it is determined that it is impossible to perform work, the process proceeds to step S107.

In step S107, the remote controller 2 displays on the display 4 that it is impossible to perform work. In this case, the automatic operation of the work machines 1a to 1d is not started.

When it is determined that it is possible to perform work in step S106, the process proceeds to step S108. In step S108, the remote controller 2 displays a work estimate on the display 4. The work estimate indicates evaluation parameters predicted for work performed by the work machines 1a to 1d according to the allocated work lanes. The evaluation parameters include, for example, estimated values of soil amount, required time, and fuel cost.

The soil amount is an amount of soil dug by the work machines 1a to 1d. The remote controller 2 calculates an estimated value of the soil amount for each of the work machines 1a to 1d. The required time is time required from the start to the completion of work. The remote controller 2 calculates an estimated value of the required time for each of the work machines 1a to 1d. The fuel cost is a cost of fuel used from the start to the completion of work. The remote controller 2 calculates an estimated value of the fuel cost for each of the work machines 1a to 1d. The remote controller 2 displays the work estimate including these estimated values on the display 4.

In step S109, the remote controller 2 determines whether an approval has been received. The operator can instruct an approval of starting work by the work machines 1a to 1d using the input device 3. The remote controller 2 determines whether the approval has been received based on an operation signal from the input device 3. The remote controller 2 may individually determine whether the approval has been received for each of the work machines 1a to 1d.

For the work lane positioned in a vicinity of the first restricted area A2, the remote controller 2 may determine that the approval has been received when an approval from the operator of each of the work machines 1a to 1d and an approval from the (shovel) operator of the shovel 6 are received. For example, as illustrated in FIG. 7, for a sixth work lane 56 and a eighth work lane 58 that are adjacent to the first restricted area A2, the remote controller 2 may determine that the approval has been received when an approval from the operator of each of the work machines 1a to 1d and an approval from the (shovel) operator of the shovel 6 are received. When the remote controller 2 receives the approval, the process proceeds to step S110.

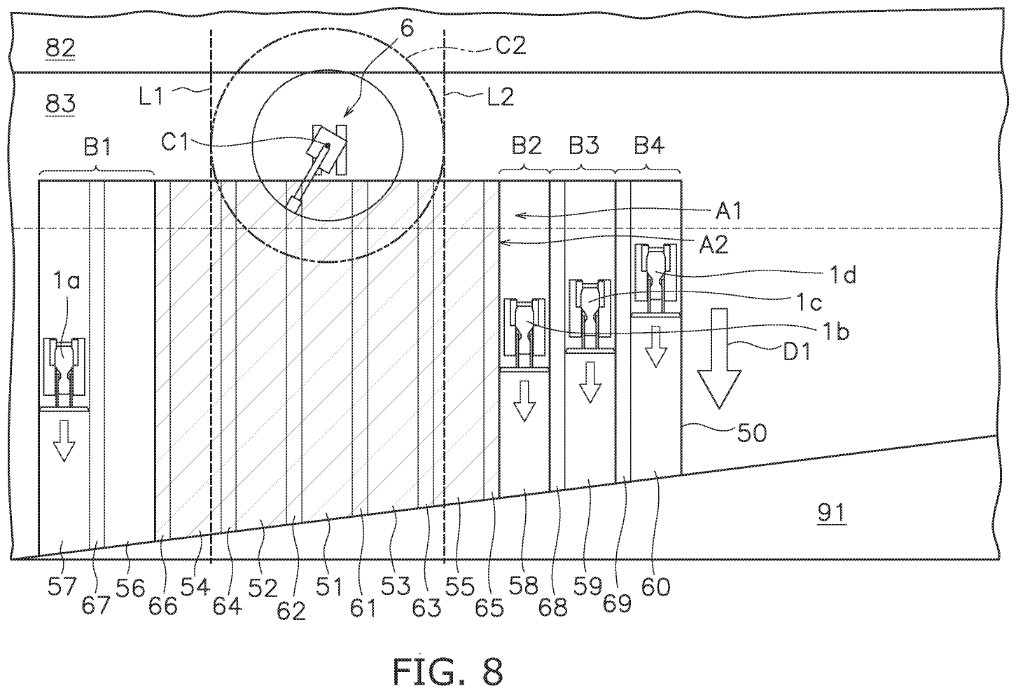

In step S110, the remote controller 2 transmits a work start command to the work machines 1a to 1d. As a result, as illustrated in FIG. 8, the work machines 1a to 1d are controlled to perform work according to the disposition of the allocated work lanes 51 to 60. The remote controller 2 transmits data indicative of positions of the work lanes 51 to 60 to the work machines 1a to 1d. The work machines 1a to 1d move to the allocated work lanes 51 to 60 and automatically align their positions and orientations with respect to the work lanes 51 to 60. Then, the work machines 1a to 1d perform digging while moving along the allocated work lanes 51 to 60. When the digging of the work lanes 51 to 60 is completed, digging walls are left between the work lanes 51 to 60. The work machines 1a to 1d dig the digging walls while moving along the allocated digging wall areas 61 to 69.

For example, as illustrated in FIG. 5, the work machine 1a operates the dozing blade 18 according to a target design topography 84. The work machine 1a starts digging while traveling forward from a first start point P1 on the actual topography 80, and drops the dug soil from the cliff. The work machine 1a travels reverse to a second start point P2. The work machine 1a starts digging while traveling forward from the second start point P2, and drops the dug soil from the cliff. The work machine 1a travels reverse to a third start point P3. The work machine 1a starts digging while traveling forward from the third start point P3, and drops the dug soil from the cliff.

By repeating such work, the work machine 1a digs the actual topography 80 so that the actual topography 80 has a shape along the target design topography 84. The other work machines 1b to 1d also dig in the allocated work lanes in the same manner as the work machines 1a. Upon completing the digging of the target design topography, the work machines 1a to 1d dig a next target design topography 85 positioned below the target design topography. The work machines 1a to 1d repeat the above work until they reach the final target topography 81 or its vicinity.

However, as illustrated in FIG. 7, the work machines 1a to 1d do not perform digging in the work lanes and the digging wall areas that are included in the first restricted area A2. That is, the remote controller 2 restricts the automatic operation of the work machines 1a to 1d in the first restricted area A2.

In an example illustrated in FIG. 8, the work machine 1a is allocated to the sixth work lane 56, a seventh work lane 57, and a seventh digging wall area 67. Therefore, the work machine 1a performs digging in an area B1 that includes the sixth work lane 56, the seventh work lane 57, and the seventh digging wall area 67. The work machine 1b is allocated to an eighth work lane 58. Therefore, the work machine 1b performs digging in an area B2 that includes the eighth work lane 58. The work machine 1c is allocated to a ninth work lane 59 and an eighth digging wall area 68. Therefore, the work machine 1c performs digging in an area B3 that includes the ninth work lane 59 and the eighth digging wall area 68. The work machine 1d is allocated to a tenth work lane 60 and a ninth digging wall area 69. Therefore, the work machine 1d performs digging in an area B4 that includes the tenth work lane 60 and the ninth digging wall area 69.

However, the work machines 1a to 1d are not allocated to the first to fifth work lanes 51 to 55 and the first to sixth digging wall areas 61 to 66 that are included in the first restricted area A2. Therefore, work by the work machines 1a to 1d is not performed in the first to fifth work lanes 51 to 55 and the first to sixth digging wall areas 61 to 66.

The automatic operation of the work machines 1a to 1d may be controlled by the remote controller 2. Alternatively, the automatic operation of the work machines 1a to 1d may be controlled by the machine controller of each of the work machines 1a to 1d. Alternatively, the control of the automatic operation of the work machines 1a to 1d may be shared by the remote controller 2 and the machine controller of each of the work machines 1a to 1d.

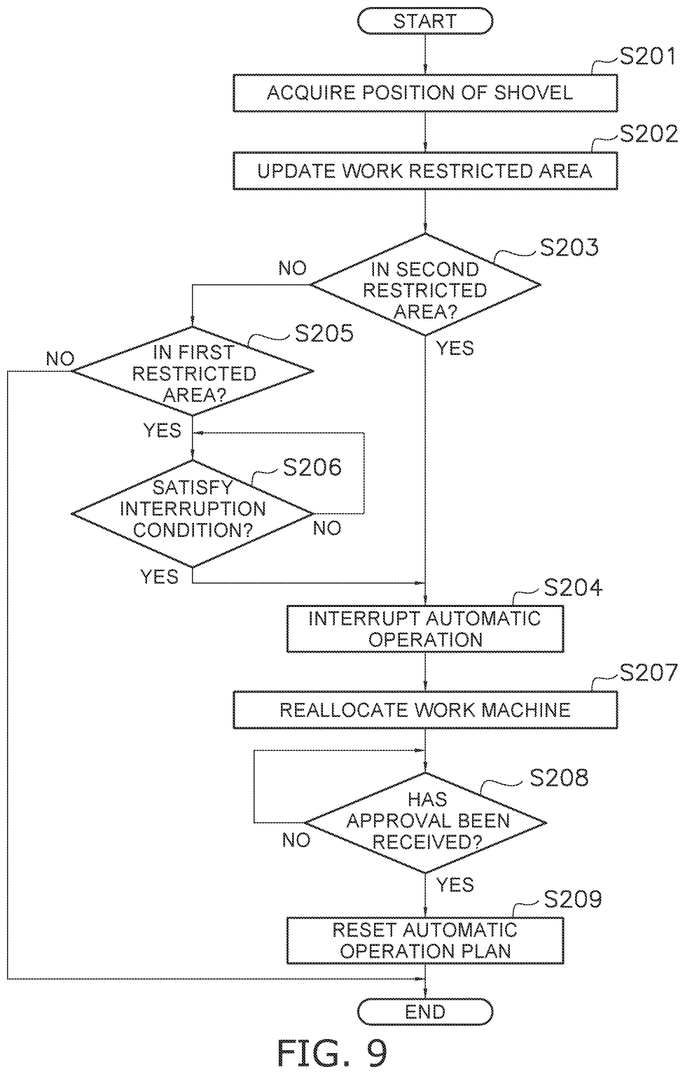

Next, processes when the shovel 6 moves during automatic operation will be described. FIG. 9 is a flowchart illustrating the processes performed by the remote controller 2 when the shovel 6 moves during the automatic operation. As illustrated in FIG. 9, in step S201, the remote controller 2 acquires a position of the shovel 6 in the same manner as in step S103.

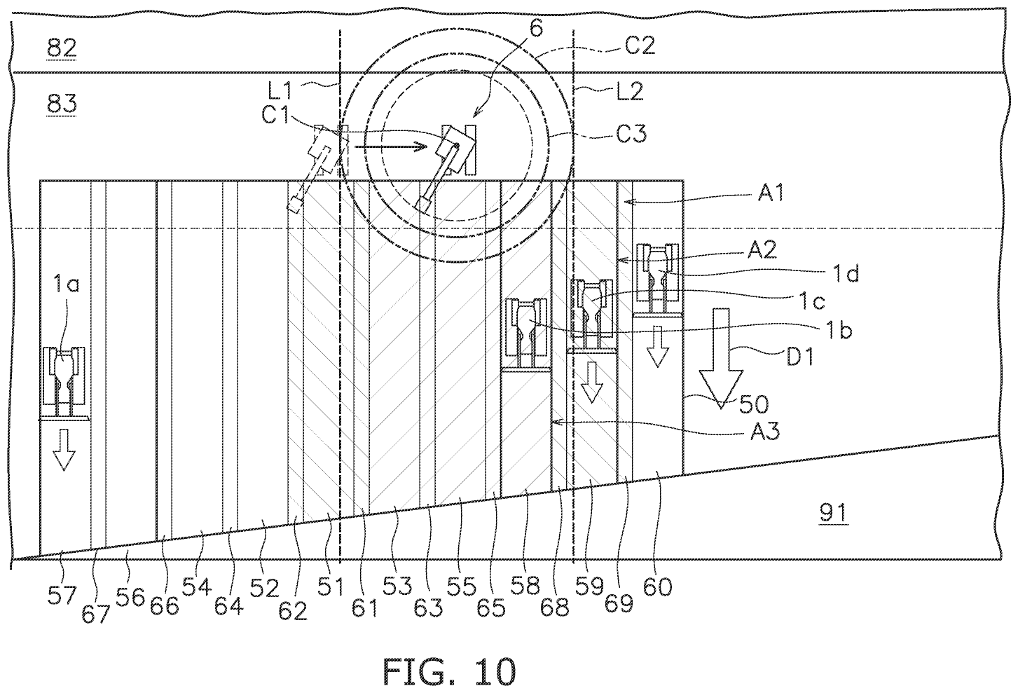

In step S202, the remote controller 2 updates the work restricted area A1. As illustrated in FIG. 10, the shovel 6 moves, whereby the position of the work restricted area A1 is updated. The remote controller 2 determines the first restricted area A2 based on the position of the shovel 6 after moving in the same manner as in step S104.

The work restricted area A1 includes a second restricted area A3. The remote controller 2 determines, as the second restricted area A3, a range that includes the work lane overlapping a rotation range of the shovel 6. For example, the remote controller 2 determines a second circle C3 centered on the position of the shovel 6. The remote controller 2 determines, as the second restricted area A3, the work lane overlapping the second circle C3. The radius of the second circle C3 is larger than the maximum rotation radius of the shovel 6. The radius of the second circle C3 may be the same as the maximum rotation radius of the shovel 6. The radius of the second circle C3 is smaller than the radius of the first circle C2.

In step S203, the remote controller 2 determines whether the work machines 1a to 1d are positioned in the second restricted area A3. When at least one of the work machines 1a to 1d is positioned in the second restricted area A3, the process proceeds to step S204.

In step S204, the remote controller 2 interrupts the automatic operation of the work machine positioned in the second restricted area A3. For example, in an example illustrated in FIG. 10, the work machine 1b is positioned in the second restricted area A3. Therefore, the remote controller 2 interrupts the automatic operation of the work machine 1b.

The remote controller 2 may immediately interrupt the automatic operation of the work machine 1b positioned in the second restricted area A3. Alternatively, the remote controller 2 may continue the automatic operation until the work being performed by the work machine 1b is completed. The remote controller 2 may stop the automatic operation of the work machine 1b, for example, when the work machine 1b completes the work from the start of digging until the work machine 1b switches to the reverse traveling. After the automatic operation is interrupted, the remote controller 2 causes the work machine 1b positioned in the second restricted area A3 to wait on standby in a stopped state.

In step S203, when the work machines 1a to 1d are not positioned in the second restricted area A3, the process proceeds to step S205. In step S205, the remote controller 2 determines whether the work machines 1a to 1d are positioned in the first restricted area A2. When at least one of the work machines 1a to 1d is positioned in the first restricted area A2, the process proceeds to step S206. In the example illustrated in FIG. 10, the remote controller 2 determines that the work machine 1c is positioned in the first restricted area A2.

In step S206, the remote controller 2 determines whether the work machine positioned in the first restricted area A2 satisfies an interruption condition. The interruption condition includes that a predetermined work being performed by the work machine is completed. The predetermined work is, for example, digging of a target design surface currently being performed. That is, when the digging of the target design surface currently being performed is completed, the remote controller 2 determines that the work machine positioned in the first restricted area A2 satisfies the interruption condition.

When the interruption condition is satisfied, the process proceeds to step S204. That is, the remote controller 2 continues the automatic operation of the work machine positioned in the first restricted area A2 until the interruption condition is satisfied. When the interruption condition is satisfied, the remote controller 2 interrupts the automatic operation of the work machine positioned in the first restricted area A2. In the example illustrated in FIG. 10, the work machine 1c is positioned in the first restricted area A2. Therefore, the remote controller 2 interrupts the automatic operation of the work machine 1c when the interruption condition is satisfied.

In step S207, the remote controller 2 reallocates the work machine. The remote controller 2 reallocates the work machine in which the automatic operation is interrupted to the work lane in the same manner as in step S105. However, allocation to the work lane included in the first restricted area A2 is disabled. Therefore, the operator can allocate the work machine to the work lane that is not included in the first restricted area A2. In the example illustrated in FIG. 10, the operator can allocate the work machine 1b or the work machine 1c to a second work lane 52 and/or the fourth work lane 54 that are not included in the first restricted area A2.

In step S208, the remote controller 2 determines whether an approval has been received in the same manner as in step S109. When the automatic operation of the plurality of work machines is interrupted, the remote controller 2 may receive an approval for each of the plurality of work machines. The remote controller 2 causes the work machine to wait on standby until the approval is received. When the remote controller 2 receives the approval, the process proceeds to step S209.

In step S209, the remote controller 2 resets an automatic operation plan. The remote controller 2 resets the automatic operation plan for the work machine that has been interrupted in its automatic operation in the same processes as in steps S105 to S110 described above. That is, the remote controller 2 allocates the work machine that has been interrupted in its automatic operation to the work lane that is not included in the first restricted area A2. The remote controller 2 determines whether it is possible to perform work, and displays a work estimate when it is possible to perform work. Then, upon receiving an approval, the remote controller 2 transmits a start command of the work machine. Accordingly, the work machine that has been interrupted in its automatic operation restarts work in the reallocated work lane. The movement of the work machine to the reallocated work lane may be manually performed by remote control of the operator.

In the control system 100 of the work machines 1a to 1d according to the present embodiment described above, the predetermined range in which the position of the shovel 6 is used as a reference at the work site is determined as the work restricted area A1. Then, the automatic operation of the plurality of work machines 1a to 1d in the work restricted area A1 is restricted. Accordingly, it is possible to prevent the work machines 1a to 1d from interfering with the shovel 6 during the automatic operation.

The remote controller 2 may stop the plurality of work machines 1a to 1d when a vehicle other than the shovel 6 and the plurality of work machines 1a to 1d intrudes into the work area 50 during the automatic operation. In this case, the remote controller 2 may restart the automatic operation when the approval is received from the operator of each of the work machines 1a to 1d in the same manner as in step S109.

Although one embodiment has been described above, the present invention is not limited to the above embodiment and various modifications may be made without departing from the gist of the invention.

The work machines 1a to 1d are not limited to bulldozers and may be other vehicles such as wheel loaders or motor graders. The work machines 1a to 1d may be vehicles driven by an electric motor.

The remote controller 2 may have a plurality of controllers separated from each other. The processes by the remote controller 2 may be distributed and executed among the plurality of controllers. The machine controller 26a may have a plurality of controllers separated from each other. The processes by the machine controller 26a may be distributed and executed among the plurality of controllers. The abovementioned processes may be distributed and executed among a plurality of processors.

The processes for setting the work plan of automatic operation described above are not limited to those of the abovementioned embodiment and may be changed, omitted, or added. The execution order of the abovementioned processes is not limited to that of the abovementioned embodiment and may be changed. A portion of the processes by the machine controller 26a may be executed by the remote controller 2. A portion of the processes by the remote controller 2 may be executed by the machine controller 26a.

The control of the work machines 1a to 1d may be fully automatic or semi-automatic. For example, the input device 3 may include an operating element such as an operating lever, a pedal, or a switch for operating the work machines 1a to 1d. The remote controller 2 may control the travel of the work machines 1a to 1d such as forward, reverse or rotating corresponding to the operation of the input device 3. The remote controller 2 may control the movement of the work implement 43 such as raising or lowering corresponding to the operation of the input device 3.

The method for determining the work area 50 is not limited to that of the above embodiment and may be changed. For example, the disposition of the work lanes in the work area 50 may be determined in advance. The method for determining the work restricted area A1 is not limited to that of the above embodiment and may be changed. For example, the first restricted area A2 may be determined based on the distance from the position of the shovel 6 in the width direction instead of the first circle C2. The second restricted area A3 may be determined based on the distance from the position of the shovel 6 in the width direction instead of the second circle C3.

The restriction of the automatic operation is not limited to that of the above embodiment and may be changed. For example, the automatic operation may be restricted by causing the work machines 1a to 1d in the work restricted area A1 to decelerate. Alternatively, the automatic operation may be restricted by causing the work machines 1a to 1d in the work restricted area A1 to move to a predetermined standby position.

According to the present disclosure, the predetermined range in which the position of the shovel is used as a reference at the work site is determined as the work restricted area. Then, the automatic operation of the work machine in the work restricted area is restricted. As a result, it is possible to prevent the work machine from interfering with the shovel during the automatic operation.

1. A system for controlling a work machine at a work site, the system comprising:
a machine position sensor configured to detect a position of the work machine at the work site;
a shovel position sensor configured to detect a position of a shovel at the work site; and
a controller configured to acquire
machine position data indicative of the position of the work machine and shovel position data indicative of the position of the shovel,
the controller being further configured to
determine a work area that includes a plurality of work lanes extending in a predetermined work direction at the work site,
allocate the work machine to the plurality of work lanes,
determine, as a work restricted area of the work machine, a predetermined range in which the position of the shovel is used as a reference at the work site, and
control the work machine so that automatic operation of the work machine in the work restricted area is restricted.

2. The system according to claim 1, wherein
the controller is further configured to disable allocation of the work machine to the work lane positioned in the work restricted area.

3. The system according to claim 1, wherein
the work restricted area includes a first restricted area, and
the controller is further configured to determine, as the first restricted area, a range that includes the work lane positioned in a range of a predetermined distance from the position of the shovel in a width direction of the work lane in which the plurality of work lanes are aligned.

4. The system according to claim 3, wherein
the controller is further configured to disable allocation of the work machine to the work lane positioned in the first restricted area in the work lane positioned in the first restricted area.

5. The system according to claim 1, wherein
the work restricted area includes a second restricted area, and
the controller is further configured to determine, as the second restricted area, a range that includes the work lane overlapping a rotation range of the shovel.

6. The system according to claim 5, wherein
the controller is further configured to interrupt the automatic operation of the work machine in the work lane positioned in the second restricted area.

7. The system according to claim 1, wherein
the controller is further configured to update the work restricted area and reallocate the work machine to the plurality of work lanes when the shovel moves.

8. The system according to claim 1, further comprising:
an input device for an operator to control the work machine,
the controller being further configured to
stop the work machine in the work lane positioned in the work restricted area,
receive an operation command from the input device for the work machine, and
allow the work machine to move based on the operation command.

9. The system according to claim 1, further comprising:
an input device configured
to receive an input command from the operator and
to output an operation command corresponding to the input command to the controller,
the work restricted area being determined based on the operation command.

10. The system according to claim 1, further comprising:
an input device for an operator to control the shovel,
the controller being further configured to
stop the work machine in the work lane positioned in the work restricted area,
receive an operation command from the input device for the shovel, and
allow the work machine to move based on the operation command.

11. The system according to claim 1, wherein
the controller is further configured to stop the work machine when a vehicle other than the shovel and the work machine intrudes into the work area.

12. A method for controlling a work machine at a work site, the method comprising:
acquiring machine position data indicative of a position of the work machine at the work site;
acquiring shovel position data indicative of a position of a shovel at the work site;
determining a work area that includes a plurality of work lanes extending in a predetermined work direction at the work site;
allocating the work machine to the plurality of work lanes;
determining, as a work restricted area of the work machine, a predetermined range in which the position of the shovel is used as a reference at the work site; and
controlling the work machine so that automatic operation of the work machine in the work restricted area is restricted.

13. The method according to claim 12, further comprising:
disabling allocation of the work machine to the work lane positioned in the work restricted area.

14. The method according to claim 12, wherein
the work restricted area includes a first restricted area, and
the method further comprises:
determining, as the first restricted area, the work lane positioned in a range of a predetermined distance from the position of the shovel in a width direction of the work lane in which the plurality of work lanes are aligned.

15. The method according to claim 14, further comprising:
disabling allocation of the work machine to the work lane positioned in the first restricted area in the work lane positioned in the first restricted area.

16. The method according to claim 12, wherein
the work restricted area includes a second restricted area, and
the method further comprises:
determining, as the second restricted area, a range that includes the work lane overlapping a rotation range of the shovel.

17. The method according to claim 16, further comprising:
interrupting the automatic operation of the work machine in the work lane positioned in the second restricted area.

18. The method according to claim 12, further comprising:
updating the work restricted area and reallocating the work machine to the plurality of work lanes when the shovel moves.

19. The method according to claim 12, further comprising:
stopping the work machine in the work lane positioned in the work restricted area; and
allowing the work machine to move based on a command from an operator.

20. The method according to claim 12, further comprising:
stopping the work machine when a vehicle other than the shovel and the work machine intrudes into the work area.
